(19) United States
(12) Patent Application Publication
(10) Pub. No.: US 2013/0213564 A1
(43) Pub. Date: Aug. 22, 2013

(54) METHOD FOR PRODUCING A COMPOSITE STRUCTURE USING FILAMENTARY WINDING WITH THERMOPLASTIC RESINS

(71) Applicants: Marco Antonio Rodrigues Souza, São Paulo (BR); Marcelo Graciani, Sao Paulo (BR)

(72) Inventors: Marco Antonio Rodrigues Souza, São Paulo (BR); Marcelo Graciani, Sao Paulo (BR)

(21) Appl. No.: 13/817,759

(22) PCT Filed: Aug. 17, 2011
(86) PCT No.: PCT/BR11/00292

§ 371 Date: Apr. 30, 2013

(30) Foreign Application Priority Data
Aug. 17, 2010 (BR) PI 1003150-2

(51) Int. Cl. B29C 53/56

(52) U.S. Cl. CPC B29C 53/562
USPC 156/169; 156/433

(57) ABSTRACT

The present invention describes the method of coating glass fibers with thermoplastic resins and the subsequent winding on tubular matrices in order to form tubular profiles of any geometry (round, square, rectangular, triangular) with thermoplastic resins, avoiding the use of thermosetting resins.

### FIELD OF APPLICATION

The present invention describes a process of coating glass fibers with thermoplastic resins and subsequent winding into tubular matrices to form a composite structure.

### DESCRIPTION OF THE PRIOR ART

Composite structures formed by continuous fiberglass filaments employ apparatuses for impregnation and subsequent winding into matrices in their manufacture. The resins used may be thermoplastic or thermosetting resins.

In the profiles produced in thermosetting resin, the continuous fiberglass filaments are impregnated in a head which aims to promote adhesion of the resin in the filaments; after that, the excess resin is removed and wound up into a profile. Then, the profile is put into an oven that promotes rotational movement not to cause draining of the resin due to high fluidity thereof and at the same time promote the curing of the resin by heating.

In the profiles produced in thermoplastic resin, the process starts with the pre-tensioning of the fibers as they transversely pass through tubes alternately; they pass through a heating chamber and after this step they pass through a container containing polymer powder. The heating of the fibers promotes adhesion of polymer micrograins along the same. In the next step, the fibers with the polymer micrograins are heated to promote the melting of the polymer along the same. The glass fiber cables are cooled and wound into coils for further processing, forming the tubular profiles.

U.S. Pat. No. 5,614,139, published on Mar. 25, 1997, describes a process with thermoplastic resin, wherein the fibers undergo this process and are immediately coated by another process step in which a thermoplastic resin compatible with the first coats the cable. The same is cooled and wound for further processing. The profile produced by this process is hot-formed and because the viscosity of thermoplastic resins is greater than that of thermosetting resins the problem of profile draining is avoided. The same wound cable is cooled and removed from the mandrel.

Current processes using thermosetting resins have a few disadvantages, for example, the thermosetting resin used has low viscosity. Such characteristic is used to promote the impregnation of glass fiber cables. However, due to low viscosity, draining may occur during the winding process, which can generate a low surface quality.

Furthermore, it is normal in these processes to have a subsequent step of heating with rotational movement of the mandrel to promote a good profile finishing.

High percentages of glass fiber are employed to promote good mechanical strength and also prevent draining of the resin. However, due to the high percentage of glass fibers it is difficult to promote a good surface finish, and the coating of the remaining resin does not enable a smooth finishing.

Additionally, in the process of filamentary winding it is usual to use winding angles to promote good mechanical strength of the product, according to FIG. 1. For the profile to have the same winding angle throughout its length it is necessary to wind the excess at the ends, which are then cut, according to FIGS. 2 and 3. These ends, because they are made from thermosetting resin with glass fiber, are not recycled, generating industrial scrap. All process waste, such as: bores, cuttings, angle cuts and defective parts originate industrial scrap of difficult recycling without further use.

Regarding the use of thermoplastic resins, the limitations of the processes currently employed in filamentary winding of glass fibers are the following:

Current processes aim to promote adhesion of polymer powder grains that are later melted and cooled. The resulting cable is then coiled for subsequent winding in the final product. This situation causes the need for two process steps, demanding the use of a greater amount of energy than actually required.

Furthermore, due to the deposition of thermoplastic resin powder in the glass fiber cable, controlled atmospheric conditions are necessary, such as temperature and humidity.

The particle size of the polymer must be well controlled, otherwise large variations in the percentage of resin and glass fiber may occur in the final product, leading to variations in quality.

Processes such as those described in U.S. Pat. No. 5,529,652, published on Jun. 25, 1996 and U.S. Pat. No. 5,176,775, published on Jan. 05, 1993, are used for impregnation of glass fiber cables, which are grouped to a single outlet and then cut or coiled for subsequent filamentary winding, adding one step to the process. This description is characterized by the vertical arrangement of the impregnation head, hindering the possible use for filamentary winding. If there are any problems, the resin head would have to be completely emptied for a new fiber splice. This does not happen with the process of the present invention.

Another situation that has disadvantages is described in patent PI 9714801-6, published on Jul. 25, 2000, and in U.S. Pat. No. 5,614,139, in which the cables are impregnated and after this step they are complemented with another extrusion step for the completion of the additives in the process. This process is intended to homogenize the quantity of additives and glass fiber in the final compound, avoiding the mixture for final applications of the compounds with other resins. This application is intended to granulated compounds not wound into a tubular die.

In the process proposed in the present application, the additives, the resin and the glass fiber are homogenized and, as no other component is added in the final winding, the percentages of the ingredients of the compound are homogeneous and uniform.

### SUMMARY OF THE INVENTION

The main object of the process of the present invention is to form tubular profiles of any geometry (round, square, rectangular, triangular) with thermoplastic resins, thereby avoiding the use of thermosetting resins.

### DESCRIPTION OF THE DRAWINGS

FIG. 1 depicts the coiling sequence of the coated filaments in a filamentary winding machine.

FIG. 2 shows the mandrel with wound cables in both directions.

FIG. 3 shows the excesses of the ends that are cut.

FIG. 4 depicts a filamentary winding mandrel.

FIG. 5 shows a conventional single screw extruder for thermoplastics.

FIG. 6 shows an open impregnation tool.

FIG. 7 shows a closed impregnation tool.

### DETAILED DESCRIPTION OF THE INVENTION

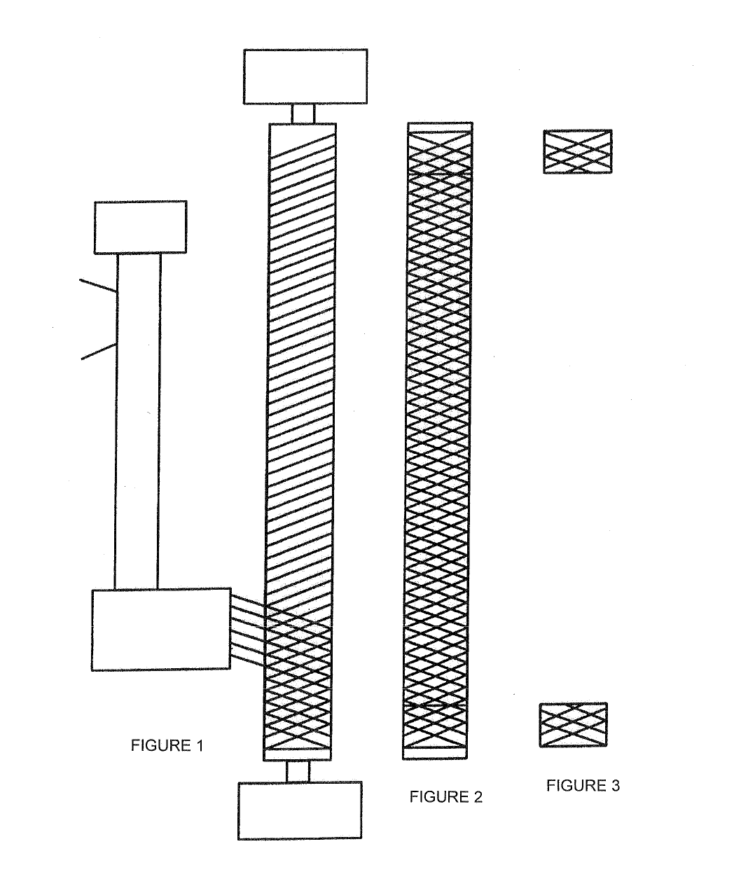

The sequence of coiling the coated filaments in a filamentary winding machine shown in FIG. 1 depicts the winding angles caused by the movement of the winding machine while winding the cables coated by the head attached to the extruder.

The mandrel with the cables wound in both directions of FIG. 2 shows the weft that is formed by the movements of the winding machine with the excess in the ends.

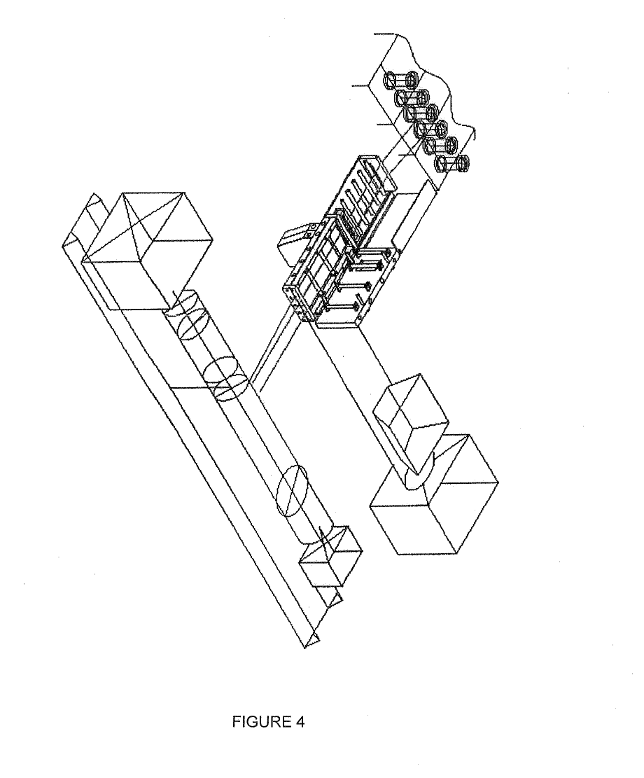

The excesses of the ends that are cut (shown in FIG. 3) are discarded in the case of the tubes in thermosetting resins, and ground and recycled in the case of thermoplastics.

The filamentary winding mandrel of FIG. 4 may have different shapes, such as: triangular, square, rectangular, round, oval, pentagonal, hexagonal, etc.

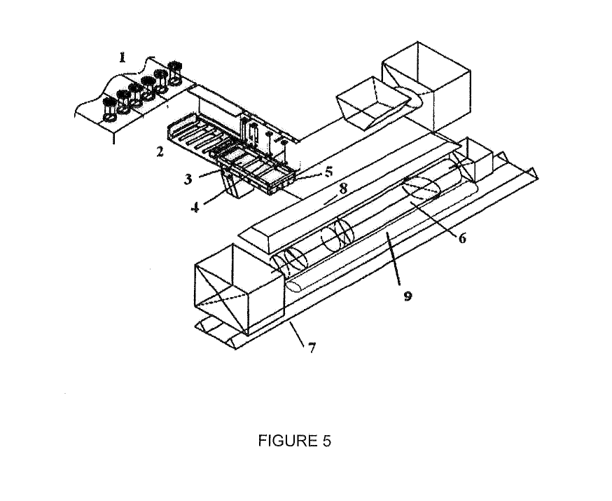

FIG. 5 shows a conventional single screw extruder for thermoplastics, containing: a rack with fiberglass roving bobbins (1), the glass fiber pre-tensioning and preheating chamber (2), the glass fiber impregnation chamber (3), crossbars which promote the impregnation of glass fiber cables (4), the outlets of the impregnation chamber with calibrated holes in the diameter (5) and also the filamentary winding machine with the property of displacement (7), the filamentary winding mandrel, which may have different shapes (6) and infrared resistances (8), the smooth finishing barrel (9).

The structure to produce tubular profiles in a glass fiber composite with thermoplastic resin through the filamentary winding process is described as follows:

The glass fibers stored in the rack (1) are arranged in parallel and guided, alternately passing through bars transversely arranged, which causes pre-tensioning thereon. At the same time they are heated by infrared resistances which aim to improve the impregnation thereof avoiding thermal shock. The chamber causing the pre-tensioning and preheating (2) is also shown in the Figure.

The glass fiber cables are kept in parallel and enter the impregnation chamber (3), wherein crossbars (4) maintain the fibers stretched and transversely receiving the thermoplastic resin in molten state. The fibers receive the thermoplastic resin in the molten state and are wetted, dragging the resin to the final part of the impregnation chamber, completely filling it. The alternate flow through the crossbars (4) promotes adhesion and the impregnation of glass fiber cables.

The coated cables, with the proportion of glass fiber and resin stabilized due to the calibrated holes (5) arranged in parallel in the impregnation tool, leave the chamber and, in a parallel arrangement, are wound in the winding machine (6).

After the cables contact the winding tool (6), they are smoothed with the smooth finishing barrel (9), leaving a smooth surface.

The winding of the cables arranged in parallel is in alternate angles, caused by the reciprocating transverse movement of the winding machine (7).

The winding tool (6) is kept heated by infrared resistances (8), which maintains the thermoplastic resin in molten state and thus enables the welding of the cables, caused by the alternating passing through the tool (6).

FIG. 6 shows an open impregnation tool.

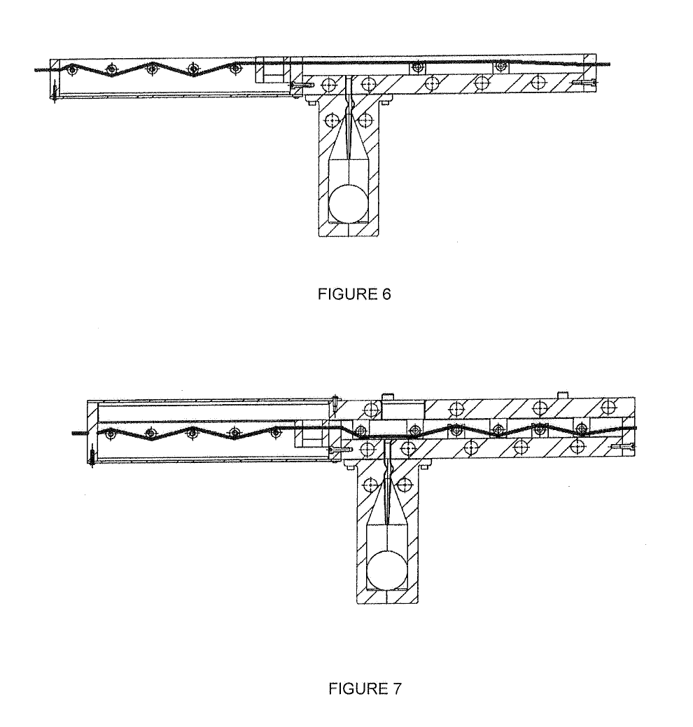

This process is different from the conventional process with thermosetting resins, wherein the impregnation head moves and the winding machine is fixed. In the filamentary winding process with thermoplastic resin the tool of FIG. 7 is fixed and the winding machine (7) moves in the direction which is transverse to winding.

The whole process is controlled by an electronic panel, wherein the winding speed and the travel speed are controlled.

The ratio between the winding speed and the travel speed gives the winding angle, without any elements between the outlet of the impregnation tool (5) and the winding tool (6).

The additions to the winding described in FIGS. 2 and 3 may be utilized as thermoplastic compounds for later use, for example, in injection molding, and any cuttings, scrap or even waste can be reused. This feature greatly differs from the current systems, because it avoids contamination of the environment, since the thermosetting compounds are currently dumped in landfills and take approximately 100 years to decompose.

As the thermoplastic resins have a higher viscosity than the thermosetting resins, better surface finishing characteristics can be achieved, avoiding later finishing or painting stages, all this due to the difficulty in draining the resin.

Furthermore, due to the use of an extruder in the process, according to FIG. 5, there is no need to control the temperature and air humidity conditions or the particle size of the polymers used, so the thermoplastic resins can be used in the form of grains, flakes, powder or ground parts.

The process of the present invention also has the advantage of not employing solvents as in processes that use thermosetting resins, thus not contaminating the environment.

The horizontal arrangement of the impregnation tool enables intervention at any stage of process, or the repair of the cables, if they break due to dirt, knots or any other situation.

Unlike the processes described in U.S. Pat. No. 5,176,775 and U.S. Pat. No. 5,529,652, the cables can be spliced or repaired with the head open, as shown in FIG. 6.

Still referring to U.S. Pat. No. 5,529,652, the crossbars through which the fibers pass are fixed. In the present invention, the crossbars are alternately fixed in the lid and base, so that only when the tool is closed, deviation is caused, as shown in FIG. 7, and when it is opened, the fiber is completely exposed for possible splicing, according to FIG. 6, facilitating the repair process.

It is important to note that in both processes with thermosetting resins and with thermoplastic resins, the deviation caused in the passage of the fibers in the resin is aimed at impregnating them. An example is described in U.S. Pat. No. 5,529,652 and U.S. Pat. No. 4,883,625.

The process employing the thermoplastic resin has the advantage of controlling the flow of polymers by controlling the processing temperature, which can range from 240° C. to 300° C. Such control enables to adjust the tension in the glass fiber cables as they pass through the resin, harmonizing the tension and finishing of the impregnated cables in the winding mandrel.

The variability in the properties of the thermoplastic resin is ensured by antioxidant additives to protect the resin from high processing temperatures. The percentages of additives or pigments in the process are guaranteed due to the initial introduction with the resin in the extruder during extrusion.

The variability of the percentage of glass fiber is the result of two conditions:

Control of the processing temperature of the resin, which causes stability of the properties, and especially of the viscosity thereof, influencing the tension and impregnation of the glass fiber cables in the resin.

The ratio of glass fiber in the resin is directly influenced by the ratio of thickness of glass fiber cables and the outlet diameter of the same in the impregnation tool, undergoing variation in the percentage of about 2 wt %, not affecting the final quality of the wound product.

The thermoplastic resins object of this process are basically: polyolefin, polyamide 6, polyamide 6.6, thermoplastic polyurethane, polyethylene terephthalate and polycarbonate, and either virgin or recycled resins may be used in any proportions, taking due care with the fluidity of the final resin used, which in this case has necessarily to have low viscosity.

1. A single screw extruder characterized by comprising a rack with glass fiber roving bobbins (1), the glass fiber cable pre-tensioning and preheating chamber (2), the glass fiber impregnation chamber (3), the crossbars (4), the outlets of the impregnation chamber with calibrated holes in the diameter (5), the filamentary winding machine with the property of displacement (7), the filamentary winding mandrel (6), the infrared resistances (8) and a smooth finishing barrel (9).

2. A method for producing a composite structure using filamentary winding with thermoplastic resins characterized by comprising the steps of:
storing the glass fiber in the rack (1) arranged in parallel and guided, alternately passing through bars transversely arranged;
heating the glass fiber by infrared resistances;
keeping the glass fiber cables that enter the impregnation chamber (3) in parallel, wherein crossbars (4) maintain the fibers stretched and transversely receiving the thermoplastic resin in molten state;
applying the thermoplastic resin in the molten state to the glass fibers which are wetted, dragging the resin to the final part of the impregnation chamber, completely filling it;
alternately passing through the crossbars (4);
winding the coated cables, with the proportion of glass fiber and resin stabilized due to the calibrated holes (5) arranged in parallel in the impregnation tool that leave the chamber and in a parallel arrangement;
smoothing the cables with the winding tool (6), with the smooth finishing barrel (9);
winding the cables arranged in parallel alternately wound in angle, caused by the reciprocating transverse movement of the winding machinery (7); and
maintaining the heating of the winding tool (6) by the infrared resistances (8).

3. The method according to claim 2, characterized in that the tool is fixed and the winding machine (7) moves in the direction which is transverse to winding.

4. The method according to claim 2, characterized in that it is controlled by an electronic panel, wherein the winding speed and the travel speed are controlled.

5. The method according to claim 4, characterized in that the ratio between the winding speed and the travel speed provides a winding angle, without any elements between the outlet of the impregnation tool (5) and the winding tool (6).

6. The method according to claim 2, characterized in that the winding of the cables coated with thermoplastic resin in mandrel can be performed in tubular shapes in round, square, rectangular or oval geometries.

7. The method according to claim 2, characterized in that the tubular geometry may be cylindrical or conical.

8. The method according to claim 2, characterized in that the thermoplastic resin is selected from a group consisting of: polypropylene (homopolymer or copolymer), polyethylene terephthalate, thermosplastic polyurethane, high density polyethylene, polyamide 6, polyamide 6.6 or polycarbonate.

9. The method according to claim 2, characterized in that the glass fiber ratios range from 25% to 80% by weight.

10. The method according to claim 2, characterized in that the use of thermoplastic resins may be in the form of grains, flakes, powder or ground parts.

11. The method according to claim 2, characterized in that crossbars are alternately fixed in the lid and base.

12. The method according to claim 2, characterized by employing the thermoplastic resin for controlling the flow of polymers by controlling the processing temperature.

13. The method according to claim 12, characterized in that the processing temperature may range from 240° C. to 300° C.

14. The method according to claim 2, characterized in that the ratio of glass fiber in the resin is directly influenced by the ratio of thickness of glass fiber cables and the outlet diameter of the same in the impregnation tool, undergoing variation in the percentage of about 2 wt %.

15. The method according to claim 1, characterized by comprising a rack with glass fiber roving bobbins (1), the glass fiber cable pre-tensioning and preheating chamber (2), the glass fiber impregnation chamber (3), the crossbars (4), the outlets of the impregnation chamber with calibrated holes in the diameter (5), the filamentary winding machine with the property of displacement (7), the filamentary winding mandrel (6), the infrared resistances (8) and a smooth finishing barrel (9).

16. The method according to claim 2, characterized by comprising a rack with glass fiber roving bobbins (1), the glass fiber cable pre-tensioning and preheating chamber (2), the glass fiber impregnation chamber (3), the crossbars (4), the outlets of the impregnation chamber with calibrated holes in the diameter (5), the filamentary winding machine with the property of displacement (7), the filamentary winding mandrel (6), the infrared resistances (8) and a smooth finishing barrel (9).

17. The method according to claim 12, characterized by comprising a rack with glass fiber roving bobbins (1), the glass fiber cable pre-tensioning and preheating chamber (2), the glass fiber impregnation chamber (3), the crossbars (4), the outlets of the impregnation chamber with calibrated holes in the diameter (5), the filamentary winding machine with the property of displacement (7), the filamentary winding mandrel (6), the infrared resistances (8) and a smooth finishing barrel (9).
